(19) United States
(12) Patent Application Publication
(10) Pub. No.: US 2025/0373162 A1
(43) Pub. Date: Dec. 4, 2025

(54) LINEAR INDUCTOR CURRENT MODELING OF COUPLED INDUCTORS

(71) Applicant: Renesas Electronics America Inc., Milpitas, CA (US)

(72) Inventors: Travis John GUTHRIE, Austin, TX (US); James Robert TOKER, Austin, TX (US); Peyman ASADI, Austin, TX (US)

(73) Assignee: Renesas Electronics America Inc., Milpitas, CA (US)

(21) Appl. No.: 19/186,861

(22) Filed: Apr. 23, 2025

Related U.S. Application Data
(60) Provisional application No. 63/653,368, filed on May 30, 2024.

(51) Int. Cl. H02M 3/158; H02M 1/32

(52) U.S. Cl. CPC H02M 3/1584; H02M 1/32

(57) ABSTRACT

Systems and methods for implementing linear inductor current modeling of coupled inductors is generally described. The method for operating a multiphase power converter comprises measuring an output voltage being provided by a multi phase power converter to a load. The multi phase power converter comprises a plurality of phases. The method further comprises measuring a plurality of phase currents of the plurality of phases. The method further comprises generating a plurality of linear inductor current models for the plurality of phases based on at least one of the output voltage, the plurality of phase currents and a plurality of inductor characteristics of output inductors in the plurality of phases.

### CROSS-REFERENCE TO RELATED APPLICATION

The present application claims the benefit of U.S. Patent Application No. 63/653,368, titled “Linear Inductor Current Modeling of Coupled Inductors” and filed on May 30, 2024, which is hereby incorporated by reference in its entirety.

### BACKGROUND

The present disclosure relates to methods and systems for power converters. Particularly, linear inductor current modeling of coupled inductors in a multiphase power converter system is described.

Power regulators or power converters, such as buck converters and boost converters, can be used for maintaining a regulated output voltage source to an electronic load. Switching power converters are used to deliver energy to the load in short power cycles and an inductor can be used to store and deliver the energy to the load. Various feedback signals, such as the measurement of inductor current, can be used to help regulate the output voltage and provide protection against over-current or faults.

### SUMMARY

In one embodiment, a method that implements linear inductor current modeling of coupled inductors is generally described. The method for operating a multiphase power converter comprises measuring an output voltage being provided by a multiphase power converter to a load. The multiphase power converter comprises a plurality of phases. The method further comprises measuring a plurality of phase currents of the plurality of phases. The method further comprises generating a plurality of linear inductor current models for the plurality of phases based on at least one of the output voltage, the plurality of phase currents and a plurality of inductor characteristics of output inductors in the plurality of phases.

In one embodiment, a system that implements linear inductor current modeling of coupled inductors is generally described. The system comprises a load and a plurality of phases. The system further comprises a controller configured to measure an output voltage being provided by the plurality of phases to a load. The controller can be further configured to measure a plurality of phase currents of the plurality of phases. The controller can be further configured to generate a plurality of linear inductor current models for the plurality of phases. Generation of the plurality of inductor current models can be based on at least one of the output voltage, the plurality of phase currents and a plurality of inductor characteristics of output inductors in the plurality of phases.

In one embodiment, a semiconductor device that implements linear inductor current modeling of coupled inductors is generally described. The semiconductor device comprises a plurality of phases. The semiconductor device further comprises a controller configured to measure an output voltage being provided by the plurality of phases to a load. The controller can be further configured to measure a plurality of phase currents of the plurality of phases. The controller can be further configured to generate a plurality of linear inductor current models for the plurality of phases. Generation of the plurality of inductor current models can be based on at least one of the output voltage, the plurality of phase currents and a plurality of inductor characteristics of output inductors in the plurality of phases.

### BRIEF DESCRIPTION OF THE DRAWINGS

FIG. 1A is a diagram showing an example system that can implement linear inductor current modeling of coupled inductors.

FIG. 1B is a diagram showing another example system that can implement linear inductor current modeling of coupled inductors.

FIG. 2 is a diagram showing an example system that can implement linear inductor current modeling of coupled inductors.

FIG. 3 is a diagram showing an example implementation of a controller that can implement linear inductor current modeling of coupled inductors.

FIG. 4 is a flow chart illustrating a process to implement linear inductor current modeling of coupled inductors.

### DETAILED DESCRIPTION

In the following description, numerous specific details are set forth, such as particular structures, components, materials, dimensions, processing steps and techniques, in order to provide an understanding of the various embodiments of the present application. However, it will be appreciated by one of ordinary skill in the art that the various embodiments of the present application may be practiced without these specific details. In other instances, well-known structures or processing steps have not been described in detail in order to avoid obscuring the present application.

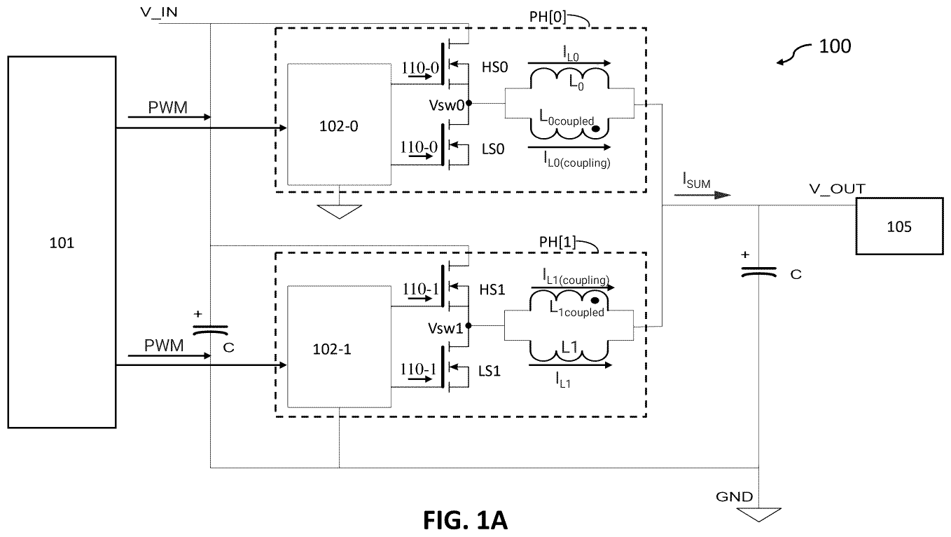

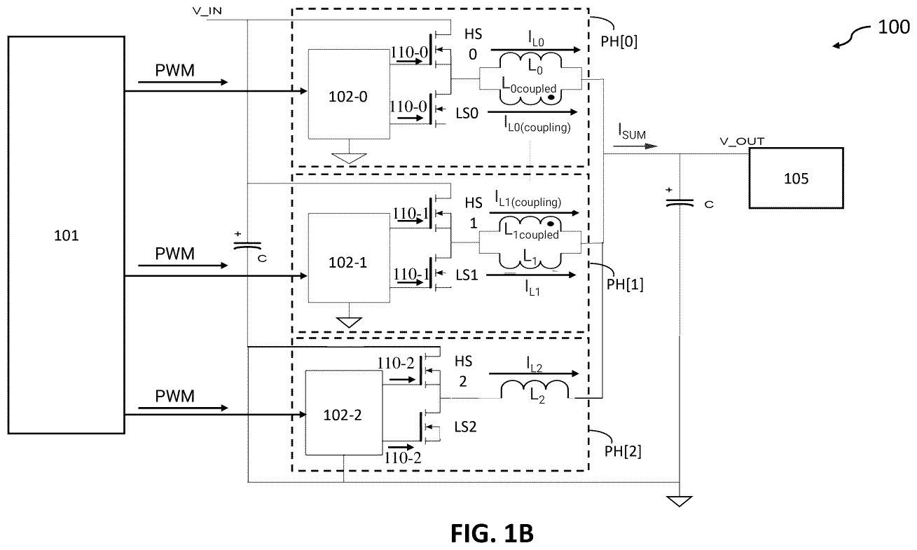

FIG. 1A is a diagram showing a system that can implement linear inductor current modeling of coupled inductors in one embodiment. A system 100 shown in FIG. 1A can be implemented by a multiphase power converter. System 100 can include at least a controller 101, a plurality of phases or power stages, and load 105. In the example shown in FIG. 1A, system 100 can include two phases labeled as PH[0] and PH[1].

Each phase in system 100 can comprise of a driver, a high-side (HS) switch and a low-side (LS) switch, and an inductor network including one or more inductors. In the example shown in FIG. 1A, phase PH[0] can comprise of a driver 102-0, a HS switch HS0, a LS switch LS0 and an inductor network comprising inductors L₀ and L_{0coupled}. In the example shown in FIG. 1A, phase PH[1] can comprise of a driver 102-1, a HS switch HS1, a LS switch LS1 and an inductor network comprising inductors L₁ and L_{1coupled}. In one embodiment, an inductor network can comprise of one passive inductor L that may not be magnetically coupled with inductors of inductor networks in other phases of system 100. In another embodiment, an inductor network can comprise of a pair of inductors connected in parallel (hereinafter “parallel inductors”). The pair of parallel inductors can comprise of a passive inductor L (or an uncoupled inductor) and a coupled inductor that can be magnetically coupled to another coupled inductor of a different phase in system 100. In the example shown in FIG. 1A, the inductor L_{0coupled} in phase PH[0] can be coupled to the inductor L_{1coupled} in phase PH[1].

In system 100 shown in FIG. 1A, each phase PH[0] and PH[1] can comprise of parallel inductors. Phase PH[0] can include a passive inductor L₀ and a coupled inductor L_{0coupled}. The coupled inductor L_{0coupled} is magnetically coupled to the inductor L_{1coupled} in phase PH[1] in parallel to passive inductor L₁. The coupling of inductors allows energy to be transferred between them through their shared magnetic field. In a multi-phase power converter, coupled inductors are used to improve performance and efficiency by reducing the overall inductor size and reduce ripples, i.e. ripple current cancelling.

Controller 101 can include, for example, a processor, microcontroller, central processing unit (CPU), field-programmable gate array (FPGA) or any other circuitry that is configured to control and operate system 100. While described as a CPU in illustrative embodiments, controller 101 is not limited to a CPU in these embodiments and may comprise any other circuitry that is configured to control and operate driver IC 102. Controller 101 can be configured to generate control signals, such as pulse width modulation (PWM) for controlling driver ICs 102 to selectively turn switches high-side (HS) and low-side (LS) in phases of system 100 on and off. HS and LS switches can be field-effect transistors (FETs) such as metal oxide semiconductor field effect transistors (MOSFETs). In other embodiments, HS and LS switches can be diodes or insulated-gate bipolar transistors (IGBTs). To be described in more detail below, controller 101 can be configured to determine and generate linear inductor current models for multi-phase power converters that include coupled inductors.

Each driver IC in the phases of system 100 can be configured to receive PWM signals from controller 101 and use the PWM signals to generate drive signals, that can be voltage signals, for turning on or off the high-side (HS) and low-side (LS) switches in a corresponding phase. Using phase PH[0] as an example, a driver IC 102-0 of phase PH[0] can drive switches HS0, LS0 and a driver IC 102-1 of phase PH[1] can drive HS1 and LS1 switches. The high-side and low-side switches in each phase can be switched alternately such that, for example, HS0 can be switched on while LS0 is switched off, and vice versa. When HS0 is switched on and LS0 is switched off, a voltage at a switch node Vsw0 between HS0 switch and LS0 switch can be pulled up to Vin such that the voltage at the switch node Vsw0 is equivalent to Vin. When HS0 is switched off and LS0 is switched on, the voltage at the switch node Vsw0 can be pulled down to ground, hence Vsw0 is equivalent to zero. Components in phase PH[1] can operate in similar manners as the components in phase PH[0].

The voltage at the switch node Vsw0 can affect the voltage across the inductor network in phase PH[0]. When Vsw0 is high (equal to Vin), the voltage across the inductor L₀ and/or L_{0coupled} is positive, causing the inductor current I_{L0} and/or I_{L0(coupling)} to increase. When Vsw0 is low (equal to ground), the voltage across the inductor L₀ is negative, causing the inductor current I_{L0} and/or I_{L0(coupling)} to decrease. The current I_{SUM} can be the total sum of all inductor currents output from each phase, i.e, PH[0] and PH[1], to be input into load 105 at output voltage V_out.

In switching power converters, such as system 100, accurate measurement of the inductor current is crucial for proper operation, including output voltage regulation and loop stability. Current-mode control can be employed to maintain output voltage regulation and enable features, such as load balancing and over-current protection, that may use inductor current across inductors L and L_{coupled}. Various techniques have been used to directly measure the instantaneous inductor current, including current ramp (up/down) and peak and valley current measurement. However, these techniques may have limitations such as power loss, heat generation, poor accuracy, and noise susceptibility, particularly at relatively high switching frequencies.

To overcome the shortcomings of direct inductor current measurement, controller 101 can include current synthesizers that utilize inductor current models to predict output current. The predictions can be used by controller 101 to adjust the PWM signals for controlling the power stages to regulate the output voltage at a target voltage level. In an aspect, the prediction of uncoupled inductors by current synthesizers can be relatively accurate due to inductor current models of uncoupled inductors being linear models. However, multiphase power conversion systems can include a mixture of uncoupled inductors and coupled inductors as shown in FIG. 1, and inductor current models of coupled inductors are non-linear models. The overall output inductor current can be based on overlap of the inductor current models from different phases, and the overlap of non-linear models (with other non-linear models or with linear models) can cause the prediction of the overall output inductor current (e.g., Isum) to be inaccurate. Due to the inaccuracies caused by non-linear models, phase balance among phases in a multiphase system becomes relatively difficult to implement. To be described in more detail below, the controller 101 can be configured to generate linear inductor current models for coupled inductors to achieve relatively more accurate inductor current prediction and provide improved phase balance among different phases in multi-phase power converters that include coupled inductors.

FIG. 1B is a diagram showing a system that can implement linear inductor current modeling of coupled inductors in another embodiment. Descriptions of FIG. 1B may reference components shown in FIG. 1A. In an example embodiment of system 100 shown in FIG. 1B, system 100 can further include a third phase PH[2]. PH[2] can comprise of a driver 102-2, a HS switch HS2, a LS switch LS2 and an inductor network comprising inductors L₂ and L_{2coupled}. Phase PH[2] can include a passive inductor L₂ that is uncoupled from other phases PH[0], PH[1]. The current I_{SUM} can be the total sum of all inductor currents output from each phase, PH[0], PH[1] and PH[2], to be input into load 105 at output voltage V_out.

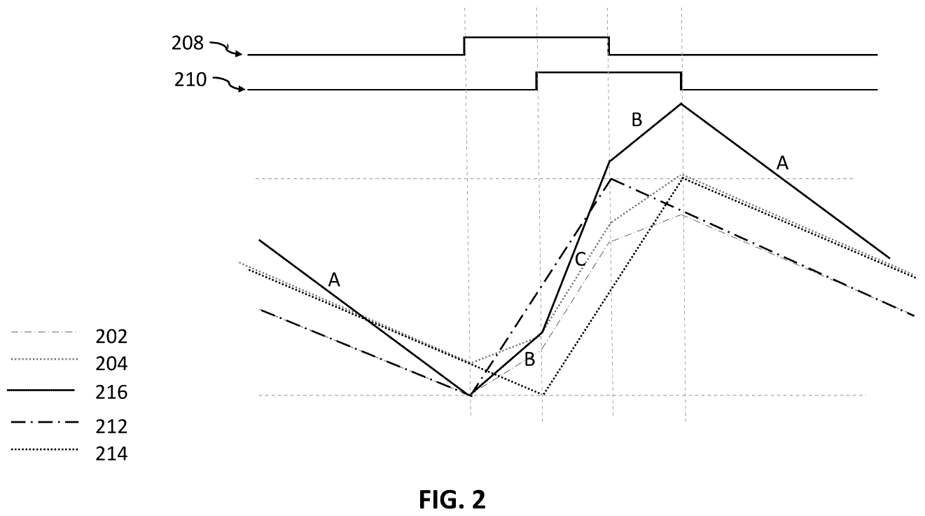

FIG. 2 is a diagram showing an implementation of linear inductor current modeling of coupled inductors in one embodiment. Descriptions of FIG. 2 may reference components shown in FIG. 1A and FIG. 1B. FIG. 2 illustrates waveforms of the equivalent inductor (LEQ) currents in each phase of a 2-phase power converter such as described in FIG. 1A. The LEQ are values generated by controller 101 based on the individual inductors and the coupling factor between the inductors, representing the effective inductance experienced by each phase PH due to the combined effect of its own inductor and the magnetic coupling with the other phases. The linear current models described in the present disclosure can model or represent, for each phase, the variation of equivalent inductor current, instead of inductor current of the output inductors of the phases. The waveform diagram in FIG. 2 shows an implementation of linear inductor current modeling of coupled inductors in an embodiment as described in FIG. 1A.

Waveform 202 illustrates the non-linear inductor current waveform of phase PH[0]. Waveform 204 illustrates the non-linear inductor current waveform of phase PH[1]. Waveform 208 illustrates the PWM signal input into the driver IC 102-1 of PH[0] and waveform 210 illustrates the PWM signal input into the driver IC 102-1 of PH[1]. Waveform 212 can be a inductor current model waveform that illustrates the LEQ current of the parallel inductors L0 and L_{0coupled} in phase PH[0]. Waveform 214 can be a inductor current model waveform that illustrates the LEQ current of the parallel inductors L1, L_{1coupled} in phase PH[1]. Waveform 216 illustrates the total estimated output current Isum being drawn from load 105. In the example embodiment shown in FIG. 2, waveform 202 shows a down-sloping waveform representing the decreasing rate of change in current across the parallel inductors L0 and L_{0coupled}. Waveform 202 continues at the consistent slope until the rising edge of the PWM waveform 208. The on time of the PWM waveform 208 causes the waveform 202 to slope upwards representing an increasing rate of change in current across the parallel inductors L0 and L_{0coupled}. When the PWM waveform 210 turns on, due to the coupled inductors between phase PH[0] and phase PH[1], the waveform 202 increases in slope at a steeper rate than previously. This represents a higher increasing rate of change in current across the parallel inductors L0 and L_{0coupled} as well as illustrates the affect of a coupled inductor onto other phases. When the PWM signal 208 turns off, i.e. reaches the falling edge, waveform 202 decreases in slope with respect to the previous slope, but continues to maintain a positive rate of change in current across the parallel inductors L0 and L_{0coupled}. When the PWM waveform 210 turns off, waveform 202 returns to a downslope similar to the beginning of the PWM cycle. Waveform 204 changes in rate in a similar manner to waveform 202. Both have non-linear characteristics due to the coupling between the two phases, making it difficult to predict the overall output inductor current.

Controller 101 of system 100 can be configured to generate linear models of coupled inductors having linear waveforms based on a coupling factor ∂. Coupling factor ∂ is a value between 0 and 1 that quantifies the strength of the magnetic coupling between two coupled inductors. The coupling factor ∂ can be used to model the current waveform for each phase adjusted for the non-linearity created by the inductor coupling. A linear slope for each phase is generated for modeling the variations in LEQ current for every on or off period of the respective PWM signal. For example, the LEQ waveforms 212 and 214 can be formed with two different slopes and the I_{SUM} waveform 216 can be formed by three different slopes A, B, and C. Note that each one of waveforms 212, 214 have a constant slope when increasing or decreasing, and each one of waveforms 202, 204 has more than slope when increasing or decreasing. Therefore, waveforms 212, 214 are relatively more linear than waveforms 202, 204, respectively.

In the example embodiment illustrated in FIG. 2, waveform 212 is generated by controller 101. Controller 101 is configured to calculate a first slope of waveform 212. The first slope of waveform 212 is based on the time PWM waveform 208 turns off to when PWM waveform 208 turns on, i.e., falling edge to rising edge. A second slope of waveform 212 is based on the time PWM waveform 208 turns on to when PWM waveform 208 turns off, i.e, rising edge to falling edge. The first slope of waveform 212 is generated by controller 101 using a relationship between the output voltage Vout and an inductance of inductor L being the total effective inductance of phase PH[0] consisting of L₀ and L_{0coupled}:−(1+∂)Vout/L. This generated first slope of waveform 212 is represented by the waveform 212 from the beginning of the PWM waveform 208 to the rising edge of the PWM waveform 208. The second slope of waveform 212 is generated by controller 101 using a relationship among the input voltage Vin, the output voltage Vout, and the inductance of inductor L being the total effective inductance of phase PH[0] consisting of L₀ and L_{0coupled}:−(1+∂)(Vin−Vout)/L. This second slope of waveform 212 is represented by the waveform 212 from the rising edge of the PWM waveform 208 to the falling edge of the PWM waveform 208. The third slope of waveform 212 would characteristically be the same as the first slope of waveform 212 because the linear model represents an inductor current without coupling caused by a different phase. Hence, the first slope of waveform 212 would be same as the third slope of waveform 212.

Waveform 214 is generated by controller 101 in the same manner to waveform 212. The first slope of waveform 214 is between the time period when the PWM waveform 210 is off. Controller 101 can generate the first slope of waveform 214 using the relationship between the output voltage Vout and an inductance of inductor L being the total effective inductance of phase PH[1] including L₁ and L_{1coupled}:−(1+∂)Vout/L and the second slope of waveform 214 using the relationship among the input voltage Vin, the output voltage Vout, and the inductance of inductor L being the total effective inductance of phase PH[1] consisting of L₁ and L_{1coupled}:−(1+∂)(Vin−Vout)/L.

Waveform 216 is a linear waveform representing the sum of the two non-linear waveforms 202 and 204, and waveform 216 is also equal to the sum of the two linear model waveforms 212 and 214. Controller 101 can be configured to combine waveforms 212, 214 to form waveform 216. Note that combining the relatively more linear behavior of waveforms 212, 214, instead of waveforms 202, 204, to generate waveform 216 can result in less processing time and power since processing linear signals uses less operations when compared to processing non-linear signals. The waveform 216 can include three slopes. The first slope A represents the off time of both PWM waveforms 208 and 210. The slope B represents the time period where only one PWM waveform 208 or 210 is on simultaneously. The third slope C represents the time period where both PWM waveforms 208 and 210 are on simultaneously. The first slope A of the total current sum waveform 216 can be generated by controller 101 using the relationship between the output voltage Vout, and the inductance of inductor L: (−2)(1+∂)Vout/L. The second slope B of the second section of the total current sum waveform 216 can be generated by controller 101 using the relationship among the input voltage Vin, the output voltage Vout, and the inductance of inductor L:(1+∂)(Vin−2*Vout)/L. Lastly, the third slope C of the total current sum waveform 216 can be calculated by controller 101 using the equation 2(1+∂)(Vin−Vout)/L.

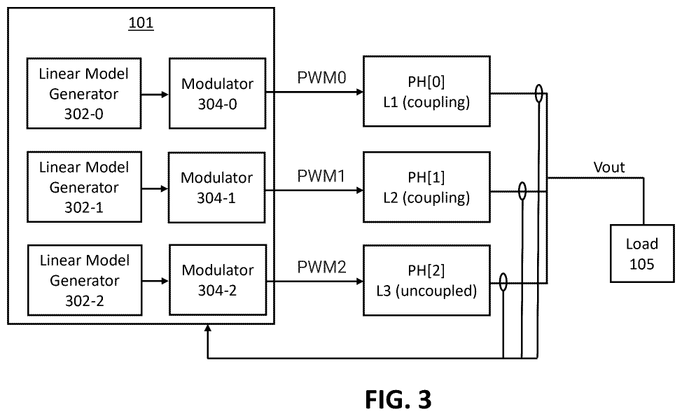

FIG. 3 is a diagram showing an example implementation of a controller that can implement linear inductor current modeling of coupled inductors. Descriptions of FIG. 3 can reference components shown in FIG. 1A, FIG. 1B an FIG. 2. In an aspect, controller 101 can include modulators 304-0, 304-1, 304-2 for generating different PWM signals PWM0, PWM1, PWM2 for phases PH[0], PH[1], PH[2], respectively. To implement generation of linear models of inductors in each phase, controller 101 can include linear model generators 302-0, 302-1, 302-2 configured to determine linear models of inductors, such as models represented by waveforms 212, 214 in FIG. 2. Each one of the linear model generators in controller 101 can be configured to generate a linear inductor current model for a corresponding phase regardless of whether the phase include uncouple inductors, coupled inductors, or a combination of both uncoupled and coupled inductors. Controller 101 can obtain feedback of the current of each phase PH[0], PH[1], PH[2], and output voltage Vout. The linear model generators in controller 101 can use the feedback of the current of each phase PH[0], PH[1], PH[2], and/or Vout along with inductor characteristics (e.g., coupling factor ∂) of inductors in corresponding phases to generate linear inductor current models. The inductor characteristics being used by controller 101 can be stored in one or more memory devices of the controller. The linear inductor current models can be provided to modulators 304-0, 304-1, 304-2 to adjust and/or generate the PWM signals PWM0, PWM1, PWM2.

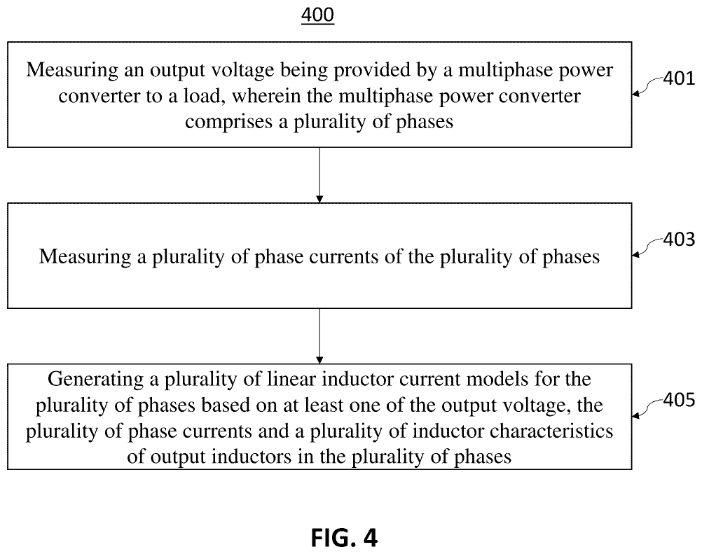

FIG. 4 is a flow chart illustrating a process to implement a multiphase power converter with linear inductor current modeling of coupled inductors in an example embodiment. A process 400 can include one or more operations, actions, or functions as illustrated by one or more of blocks 401, 403, and/or 405. Although illustrated as discrete blocks, various blocks can be divided into additional blocks, combined into fewer blocks, eliminated, performed in different order, or performed in parallel, depending on the desired implementation.

Process 400 can be performed by a controller of a multiphase power converter. Process 400 can begin at block 401, where the controller can measure an output voltage being provided by a multiphase power converter to a load, wherein the multiphase power converter comprises a plurality of phases. Process 400 can continue from block 401 to block 403. At block 403, the controller can measure a plurality of phase currents of the plurality of phases. Process 400 can continue from block 403 to block 405. At block 405, the controller can generate a plurality of linear inductor current models for the plurality of phases based on at least one of the output voltage, the plurality of phase currents and a plurality of inductor characteristics of output inductors in the plurality of phases.

In another embodiment, each one of the plurality of phases comprises at least one coupled inductor. In another embodiment, the plurality of phases comprises a combination of coupled inductors and uncoupled inductors. In another embodiment, the plurality of inductor characteristics comprises: a plurality of coupling factors of coupled inductors among the plurality of phases; and inductance values of the output inductors in the plurality of phases.

In another embodiment, generating the plurality of inductor current models further comprises, for each particular phase among of the plurality of phases: measuring an inductor current of the particular phase, generating a linear inductor current model for the particular phase based on the output voltage, the inductor current of the particular phase and inductor characteristics of an output inductor network of the particular phase, and combining the plurality of linear inductor current models to predict a total amount of current being drawn by the load. In another embodiment, the controller can generate a plurality of control signals for the plurality of phases using the plurality of linear inductor current models. In another embodiment, each one of the plurality of inductor current models represent variations of an equivalent inductor current of a corresponding phase.

### EXAMPLES

Example 1: A method for operating a multiphase power converter, the method comprising: measuring an output voltage being provided by a multiphase power converter to a load, wherein the multiphase power converter comprises a plurality of phases; measuring a plurality of phase currents of the plurality of phases; and generating a plurality of linear inductor current models for the plurality of phases based on at least one of the output voltage, the plurality of phase currents and a plurality of inductor characteristics of output inductors in the plurality of phases.

Example 2: The method of example 1, wherein each one of the plurality of phases comprises at least one coupled inductor.

Example 3: The method of any one of examples 1 to 2, wherein the plurality of phases comprises a combination of coupled inductors and uncoupled inductors.

Example 4: The method of any one of examples 1 to 3, wherein the plurality of inductor characteristics comprises: a plurality of coupling factors of coupled inductors among the plurality of phases; and inductance values of the output inductors in the plurality of phases.

Example 5: The method of any one of examples 1 to 4, wherein generating the plurality of inductor current models further comprises, for each particular phase among of the plurality of phases: measuring an inductor current of the particular phase; generating a linear inductor current model for the particular phase based on the output voltage, the inductor current of the particular phase and inductor characteristics of an output inductor network of the particular phase; and combining the plurality of linear inductor current models to predict a total amount of current being drawn by the load.

Example 6: The method of any one of examples 1 to 5, further comprising generating a plurality of control signals for the plurality of phases using the plurality of linear inductor current models.

Example 7: The method of any one of examples 1 to 6, wherein each one of the plurality of inductor current models represent variations of an equivalent inductor current of a corresponding phase.

Example 8: A system comprising: a load; a plurality of phases, and a controller configured to: measure an output voltage being provided by the plurality of phases to the load; measure a plurality of phase currents of the plurality of phases; and generate a plurality of linear inductor current models for the plurality of phases, wherein generation of the plurality of inductor current models is based on at least one of the output voltage, the plurality of phase currents and a plurality of inductor characteristics of output inductors in the plurality of phases.

Example 9: The system of example 8, wherein each one of the plurality of phases comprises at least one coupled inductor.

Example 10: The system of any one of examples 8 to 9, wherein the plurality of phases comprises a combination of coupled inductors and uncoupled inductors.

Example 11: The system of any one of examples 8 to 10, wherein the plurality of inductor characteristics comprises: a plurality of coupling factors of coupled inductors among the plurality of phases; and inductance values of the output inductors in the plurality of phases.

Example 12: The system of any one of examples 8 to 11, wherein to generate the plurality of inductor current models, the controller is configured to: measure an inductor current of the particular phase; and generate a linear inductor current model for the particular phase based on the output voltage, the inductor current of the particular phase and inductor characteristics of an output inductor network of the particular phase; and combine the plurality of linear inductor current models to predict a total amount of current being drawn by the load.

Example 13: The system of any one of examples 8 to 12, wherein the controller is configured to generate a plurality of control signals for the plurality of phases using the plurality of linear inductor current models.

Example 14: The system of any one of examples 8 to 13, wherein each one of the plurality of inductor current models represent variations of an equivalent inductor current of a corresponding phase.

Example 15: A semiconductor device comprising: a plurality of phases, and a controller configured to: measure an output voltage being provided by the plurality of phases to a load; measure a plurality of phase currents of the plurality of phases; and generate a plurality of linear inductor current models for the plurality of phases, wherein generation of the plurality of inductor current models is based on at least one of the output voltage, the plurality of phase currents and a plurality of inductor characteristics of output inductors in the plurality of phases.

Example 16: The semiconductor device of example 15, wherein each one of the plurality of phases comprises at least one coupled inductor.

Example 17: The semiconductor device of any one of examples 15 to 16, wherein the plurality of phases comprises a combination of coupled inductors and uncoupled inductors.

Example 18: The semiconductor device of any one of examples 15 to 17, wherein the plurality of inductor characteristics comprises: a plurality of coupling factors of coupled inductors among the plurality of phases; and inductance values of the output inductors in the plurality of phases.

Example 19: The semiconductor device of any one of examples 15 to 18, wherein to generate the plurality of inductor current models, the controller is configured to: measure an inductor current of the particular phase; generate a linear inductor current model for the particular phase based on the output voltage, the inductor current of the particular phase and inductor characteristics of an output inductor network of the particular phase; and combine the plurality of linear inductor current models to predict a total amount of current being drawn by the load.

Example 20: The semiconductor device of any one of examples 15 to 19, wherein the controller is configured to generate a plurality of control signals for the plurality of phases using the plurality of linear inductor current models.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements, if any, in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. M any modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

What is claimed is:

1. A method for operating a multiphase power converter, the method comprising:
measuring an output voltage being provided by a multiphase power converter to a load, wherein the multiphase power converter comprises a plurality of phases;
measuring a plurality of phase currents of the plurality of phases; and
generating a plurality of linear inductor current models for the plurality of phases based on at least one of the output voltage, the plurality of phase currents and a plurality of inductor characteristics of output inductors in the plurality of phases.

2. The method of claim 1, wherein each one of the plurality of phases comprises at least one coupled inductor.

3. The method of claim 1, wherein the plurality of phases comprises a combination of coupled inductors and uncoupled inductors.

4. The method of claim 1, wherein the plurality of inductor characteristics comprises:
a plurality of coupling factors of coupled inductors among the plurality of phases; and
inductance values of the output inductors in the plurality of phases.

5. The method of claim 1, wherein generating the plurality of linear inductor current models further comprises, for each particular phase among of the plurality of phases:
measuring an inductor current of the particular phase;
generating a linear inductor current model for the particular phase based on the output voltage, the inductor current of the particular phase and inductor characteristics of an output inductor network of the particular phase; and
combining the plurality of linear inductor current models to predict a total amount of current being drawn by the load.

6. The method of claim 1, further comprising generating a plurality of control signals for the plurality of phases using the plurality of linear inductor current models.

7. The method of claim 1, wherein each one of the plurality of linear inductor current models represent variations of an equivalent inductor current of a corresponding phase.

8. A system comprising:
a load;
a plurality of phases, and
a controller configured to:
measure an output voltage being provided by the plurality of phases to the load;
measure a plurality of phase currents of the plurality of phases; and
generate a plurality of linear inductor current models for the plurality of phases, wherein generation of the plurality of linear inductor current models is based on at least one of the output voltage, the plurality of phase currents and a plurality of inductor characteristics of output inductors in the plurality of phases.

9. The system of claim 8, wherein each one of the plurality of phases comprises at least one coupled inductor.

10. The system of claim 8, wherein the plurality of phases comprises a combination of coupled inductors and uncoupled inductors.

11. The system of claim 8, wherein the plurality of inductor characteristics comprises:
a plurality of coupling factors of coupled inductors among the plurality of phases; and
inductance values of the output inductors in the plurality of phases.

12. The system of claim 8, wherein to generate the plurality of linear inductor current models, the controller is configured to:
measure an inductor current of a particular phase;
generate a linear inductor current model for the particular phase based on the output voltage, the inductor current of the particular phase and inductor characteristics of an output inductor network of the particular phase; and
combine the plurality of linear inductor current models to predict a total amount of current being drawn by the load.

13. The system of claim 8, wherein the controller is configured to generate a plurality of control signals for the plurality of phases using the plurality of linear inductor current models.

14. The system of claim 12, wherein each one of the plurality of linear inductor current models represent variations of an equivalent inductor current of a corresponding phase.

15. A semiconductor device comprising:
a plurality of phases, and
a controller configured to:
measure an output voltage being provided by the plurality of phases to a load;
measure a plurality of phase currents of the plurality of phases; and
generate a plurality of linear inductor current models for the plurality of phases, wherein generation of the plurality of linear inductor current models is based on at least one of the output voltage, the plurality of phase currents and a plurality of inductor characteristics of output inductors in the plurality of phases.

16. The semiconductor device of claim 15, wherein each one of the plurality of phases comprises at least one coupled inductor.

17. The semiconductor device of claim 15, wherein the plurality of phases comprises a combination of coupled inductors and uncoupled inductors.

18. The semiconductor device of claim 15, wherein the plurality of inductor characteristics comprises:
a plurality of coupling factors of coupled inductors among the plurality of phases; and
inductance values of the output inductors in the plurality of phases.

19. The semiconductor device of claim 15, wherein to generate the plurality of linear inductor current models, the controller is configured to:
measure an inductor current of a particular phase;
generate a linear inductor current model for the particular phase based on the output voltage, the inductor current of the particular phase and inductor characteristics of an output inductor network of the particular phase; and
combine the plurality of linear inductor current models to predict a total amount of current being drawn by the load.

20. The semiconductor device of claim 15, wherein the controller is configured to generate a plurality of control signals for the plurality of phases using the plurality of linear inductor current models.
